(19) United States
(12) Patent Application Publication
(10) Pub. No.: US 2025/0113384 A1
(43) Pub. Date: Apr. 3, 2025

(54) METHOD AND APPARATUS FOR LAYER1/LAYER2 TRIGGERED MOBILITY (LTM) IN WIRELESS NETWORKS

(71) Applicant: SHARP KABUSHIKI KAISHA, Osaka (JP)

(72) Inventors: CHIA-HSIN LAI, Tapei (TW); MEI-JU SHIH, Taipei (TW); YEN-HUA LI, Taipei (TW); WAN-CHEN LIN, Taipei (TW); CHIA-HUNG LIN, Taipei (TW)

(21) Appl. No.: 18/897,355

(22) Filed: Sep. 26, 2024

Related U.S. Application Data
(60) Provisional application No. 63/585,282, filed on Sep. 26, 2023.

(51) Int. Cl. H04W 74/0833; H04W 72/1273

(52) U.S. Cl. CPC H04W 74/0833; H04W 72/1273

(57) ABSTRACT

A method performed by a User Equipment (UE) for a Layer1/Layer2 Triggered Mobility (LTM) operation is provided. The method receives, from a source cell, an LTM cell switch command Medium Access Control (MAC) Control Element (CE) including a Timing Advance Command (TAC) field. The method switches from the source cell to a target cell in response to receiving the LTM cell switch command MAC CE. In a case that the TAC field is set to an invalid value, the method performs a Random Access (RA) procedure with the target cell upon switching to the target cell, where a type of the RA procedure depends on whether the LTM cell switch command MAC CE further includes a Contention-Free Random Access (CFRA)-related field. In a case that the TAC field is set to a valid value, the method skips the RA procedure with the target cell upon switching to the target cell.

### CROSS-REFERENCE TO RELATED APPLICATION(S)

The present disclosure claims the benefit of and priority to U.S. Provisional Patent Application Ser. No. 63/585,282, filed on Sep. 26, 2023, entitled “METHOD AND APPARATUS TO DESIGN CSC MAC CE FOR LTM,” the content of which is hereby incorporated herein fully by reference into the present disclosure for all purposes.

### FIELD

The present disclosure is related to wireless communication and, more specifically, to a User Equipment (UE), Base Station (BS), and method for a Layer1/Layer2 Triggered Mobility (LTM) operation in the wireless communication networks.

### BACKGROUND

Various efforts have been made to improve different aspects of wireless communication for the cellular wireless communication systems, such as the 5th Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). As the demand for radio access continues to grow, however, there exists a need for further improvements in the next-generation wireless communication systems, such as improvements in LTM operations.

### SUMMARY

The present disclosure is related to a UE, a BS, and a method for an LTM operation in the wireless communication networks.

In a first aspect of the present disclosure, a method performed by a UE for an LTM operation is provided. The method includes receiving, from a source cell, an LTM cell switch command Medium Access Control (MAC) Control Element (CE) including a Timing Advance Command (TAC) field; determining whether the LTM cell switch command MAC CE further includes a Contention-Free Random Access (CFRA)-related field; switching from the source cell to a target cell in response to receiving the LTM cell switch command MAC CE; in a case that the TAC field is set to an invalid value, performing a Random Access (RA) procedure with the target cell upon switching to the target cell, where a type of the RA procedure depends on whether the LTM cell switch command MAC CE includes the CFRA-related field; and in a case that the TAC field is set to a valid value, skipping the RA procedure with the target cell upon switching to the target cell.

In some implementations of the first aspect, the type of the RA procedure is a CFRA type in a case that the LTM cell switch command MAC CE includes the CFRA-related field, and the type of the RA procedure is a Contention-Based Random Access (CBRA) type in a case that the LTM cell switch command MAC CE does not include the CFRA-related field.

In some implementations of the first aspect, the CFRA-related field includes at least one of a preamble index, a mask index, and a Synchronization Signal/Physical Broadcast Channel (SS/PBCH) Block (SSB) index.

In some implementations of the first aspect, the invalid value is ‘FFF’ in hexadecimal notation.

In some implementations of the first aspect, the valid value corresponds to an index of a Timing Advance (TA) value for the target cell.

In some implementations of the first aspect, the LTM cell switch command MAC CE further includes an indication field for indicating whether the LTM cell switch command MAC CE comprises the CFRA-related field.

In some implementations of the first aspect, performing the RA procedure with the target cell includes monitoring a Downlink Control Information (DCI) format with Cyclic Redundancy Check (CRC) scrambled by a Random Access-Radio Network Temporary Identifier (RA-RNTI), a Message B-RNTI (MsgB-RNTI), or a Temporary Cell-RNTI (TC-RNTI) in a search space on the target cell.

In a second aspect of the present disclosure, a UE for an LTM operation is provided. The UE includes at least one processor and at least one non-transitory computer-readable medium that is coupled to the at least one processor and that stores one or more computer-executable instructions. The computer-executable instructions, when executed by the at least one processor, cause the UE to: receive, from a source cell, an LTM cell switch command MAC CE including a TAC field; determine whether the LTM cell switch command MAC CE further includes a CFRA-related field; switch from the source cell to a target cell in response to receiving the LTM cell switch command MAC CE; in a case that the TAC field is set to an invalid value, perform an RA procedure with the target cell upon switching to the target cell, where a type of the RA procedure depends on whether the LTM cell switch command MAC CE includes the CFRA-related field; and in a case that the TAC field is set to a valid value, skip the RA procedure with the target cell upon switching to the target cell.

In a third aspect of the present disclosure, a BS for an LTM operation is provided. The BS includes at least one processor and at least one non-transitory computer-readable medium that is coupled to the at least one processor and that stores one or more computer-executable instructions. The computer-executable instructions, when executed by the at least one processor, cause the BS to: transmit, to a UE, via a source cell associated with the BS, an LTM cell switch command MAC CE including a TAC field. The UE determines whether the LTM cell switch command MAC CE further includes a CFRA-related field. The UE switches from the source cell to a target cell in response to receiving the LTM cell switch command MAC CE. In a case that the TAC field is set to an invalid value, the UE performs an RA procedure with the target cell upon switching to the target cell, where a type of the RA procedure depends on whether the LTM cell switch command MAC CE includes the CFRA-related field. In a case that the TAC field is set to a valid value, the UE skips the RA procedure with the target cell upon switching to the target cell.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a flowchart illustrating a method/process performed by a UE for an LTM operation, according to an example implementation of the present disclosure.

FIG. 2 is a block diagram illustrating a node for wireless communication, according to an example implementation of the present disclosure.

### DETAILED DESCRIPTION

Some of the abbreviations used in the present disclosure include:

| Abbreviation | Full name |
|---|---|
| 3GPP | 3^{rd} Generation Partnership Project |
| 5G | 5^{th} Generation |
| ACK | Acknowledgment |
| BS | Base Station |
| BWP | Bandwidth Part |
| C-RNTI | Cell RNTI |
| CA | Carrier Aggregation |
| CBRA | Contention-Based Random Access |
| CC | Component Carrier |
| CFRA | Contention-Free Random Access |
| CG | Configured Grant |
| CHO | Conditional Handover |
| CRC | Cyclic Redundancy Check |
| CS-RNTI | Configured Scheduling RNTI |
| CSC | Cell Switch Command |
| CSI | Channel State Information |
| CSI-RS | Channel State Information Reference Signal |
| CSS | Common Search Space |
| DC | Dual Connectivity |
| DCI | Downlink Control Information |
| DL | Downlink |
| DM-RS | Demodulation Reference Signal |
| DRB | Data Radio Bearer |
| E-UTRA | Evolved Universal Terrestrial Radio Access |
| eLCID | Extended Logical Channel ID |
| FDD | Frequency Division Duplex |
| FR | Frequency Range |
| HARQ | Hybrid Automatic Repeat Request |
| HARQ-ACK | HARQ Acknowledgement |
| HO | Handover |
| ID | Identifier |
| IE | Information Element |
| L1/L2/L3 | Layer 1/Layer 2/Layer 3 |
| LCID | Logical Channel ID |
| LCP | Logical Channel Prioritization |
| LTE | Long Term Evolution |
| LTM | Layer1/Layer2 Triggered Mobility |
| MAC | Medium Access Control |
| MAC CE | MAC Control Element |
| MCG | Master Cell Group |
| MCS | Modulation and Coding Scheme |
| MN | Master Node |
| Msg | Message |
| NAS | Non Access Stratum |
| NDI | New Data Indicator |
| NES | Network Energy Saving |
| NG-RAN | Next Generation RAN |
| NR | New Radio |
| NUL | Normal Uplink |
| NW | Network |
| NZP | Non-Zero Power |
| OFDM | Orthogonal Frequency Division Multiplexing |
| PBCH | Physical Broadcast Channel |
| PCell | Primary Cell |
| PCI | Physical Cell Identifier |
| PDCCH | Physical Downlink Control Channel |
| PDCP | Packet Data Convergence Protocol |
| PDSCH | Physical Downlink Shared Channel |
| PHY | Physical (layer) |
| PRACH | Physical Random Access Channel |
| PSCell | Primary SCG Cell |
| PTAG | Primary Timing Advance Group |
| PUCCH | Physical Uplink Control Channel |
| PUSCH | Physical Uplink Shared Channel |
| QCL | Quasi Co-Location |
| QoS | Quality of Service |
| RA | Random Access |
| RACH | Random Access Channel |
| RAN | Radio Access Network |
| RAR | Random Access Response |
| Rel | Release |
| RF | Radio Frequency |
| RLC | Radio Link Control |
| RLF | Radio Link Failure |
| RNTI | Radio Network Temporary Identifier |
| RRC | Radio Resource Control |
| RS | Reference Signal |
| RSRP | Reference Signal Received Power |
| Rx | Reception |
| SCell | Secondary Cell |
| SCG | Secondary Cell Group |
| SDAP | Service Data Adaptation Protocol |
| SDM | Spatial Division Multiplexing |
| SI | System Information |
| SIB | System Information Block |
| SL | Sidelink |
| SN | Secondary Node |
| SpCell | Special Cell |
| SPS | Semi-Persistent Scheduling |
| SR | Scheduling Request |
| SRS | Sounding Reference Signal |
| SS | Synchronization Signal |
| SSB | SS/PBCH Block |
| SUL | Supplementary Uplink |
| TA | Timing Advance |
| TAC | Timing Advance Command |
| TAG | Timing Advance Group |
| TB | Transport Block |
| TC-RNTI | Temporary Cell-RNTI |
| TCI | Transmission Configuration Indicator |
| TDD | Time Division Duplex |
| TRP | Transmission Reception Point |
| TR | Technical Report |
| TS | Technical Specification |
| Tx | Transmission |
| UE | User Equipment |
| UL | Uplink |
| URLLC | Ultra-Reliable and Low-Latency Communication |
| V2X | Vehicle to Everything |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not illustrated) by the same numerals in the drawings. However, the features in different implementations may be different in other respects and may not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “In some implementations,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs. A network (NW) may include a network node, a TRP, a cell (e.g., SpCell, PCell, PSCell, and/or SCell), an eNB, a gNB, and/or a base station.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface. Although the gNB is used as an example in some implementations within the present disclosure, it should be noted that the disclosed implementations may also be applied to other types of base stations.

The BS may be operable to provide radio coverage to a specific geographical area using multiple cells forming the RAN. The BS may support the operations of the cells. Each cell may be operable to provide services to at least one UE within its radio coverage.

Each cell (may often referred to as a serving cell) may provide services to one or more UEs within the cell's radio coverage, such that each cell schedules the DL (and optionally UL resources) to at least one UE within its radio coverage for DL (and optionally UL packet transmissions from the UE). The BS may communicate with one or more UEs in the radio communication system via the cells. The serving cell may include a PCell, a PSCell, or an SCell. The serving cell may be an activated or a deactivated serving cell.

A cell may allocate sidelink (SL) resources for supporting the Proximity Services (ProSe) or Vehicle to Everything (V2X) services. Each cell may have overlapped coverage areas with other cells.

In Multi-RAT Dual Connectivity (MR-DC) cases, the primary cell of a Master Cell Group (MCG) or a Secondary Cell Group (SCG) may be referred to as a Special Cell (SpCell). A Primary Cell (PCell) may include the SpCell of an MCG. A Primary SCG Cell (PSCell) may include the SpCell of an SCG. MCG may include a group of serving cells associated with the Master Node (MN), including the SpCell and optionally one or more Secondary Cells (SCells). An SCG may include a group of serving cells associated with the Secondary Node (SN), including the SpCell and optionally one or more SCells. The SpCell may support the PUCCH transmission and the contention-based Random Access and may be always activated.

As discussed above, the frame structure for NR may support flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes may be considered for NR, specifically, Low-Density Parity-Check (LDPC) code and Polar Code. The coding scheme adaption may be configured based on channel conditions and/or service applications.

At least the DL transmission data, a guard period, and UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

In some implementations, all the designs/embodiment/implementations introduced within this disclosure are not limited to be applied for dealing with the problems discussed within this disclosure. For example, the described embodiments may be applied to solve other problems that exist in the RAN of wireless communication systems. In some implementations, all of the numbers listed within the designs/embodiment/implementations introduced within this disclosure are just examples and for illustration, for example, of how the described methods are executed.

### LTM Cell Switch Command MAC CE

An LTM Cell Switch Command (CSC) MAC CE may be identified by a MAC subheader with an eLCID. The LTM CSC MAC CE may have/include at least one of the following fields:
R: Reserved bit, which may be set to 0.
Target Configuration ID: This field may indicate the index of a candidate target configuration to apply for the LTM cell switching, corresponding to a higher layer parameter (e.g., the Itm-CandidateId). The length of this field may be 3 bits.
Timing Advance Command (TAC): This field may indicate whether the TA is valid for the LTM target cell (e.g., the SpCell corresponding to the target configuration indicated by the Target Configuration ID field). For example, if the value of this field is set to ‘FFF’ in hexadecimal notation (e.g., if the length of the field is 12 bits, all the 12 bits may be set to ‘1’), this field may indicate that no valid timing adjustment is available for the PTAG of the LTM target cell. In that scenario, the UE may perform a random access procedure with the LTM target cell. Otherwise, when the field indicates the index value Ta that is used to control the amount of timing adjustment that the MAC entity may have to apply, the UE may skip the random access procedure for the LTM cell switching. The length of this field, as indicated above, may be 12 bits.
TCI state ID: This field may indicate and/or activate the TCI state for the LTM target cell (e.g., the SpCell of the target configuration indicated by the Target Configuration ID field). The TCI state may be identified by the TOI-Stateld. If the value of a unified TCI state type (e.g., the unifiedT (′I-State Type) in the SpCell of the target configuration, indicated by the Target Configuration ID field, is joint, this field may be for the joint TCI state; otherwise, this field may be for the downlink TCI state. The length of this field may be 7 bits.
UL TCI state ID: This field may indicate and/or activate the uplink TCI state for the LTM target cell (e.g., the SpCell of the target configuration indicated by the Target Configuration ID field). The most significant bits of the UL TCI state ID may be considered as reserved bits, and the remaining 6 bits may indicate the TOI-UIL-Stateld. This field may be present if the value of the unified TCI state type (e.g., the unifiedT (′I-State Type) in the SpCell, corresponding to the target configuration, indicated by the Target Configuration ID field, is separate. The length of the field may be predefined, such as a specific number of bits (e.g., 8 bits).
CFRA info: This field may include some information related to the CFRA. It should be noted that this field may be referred to as “CFRA information field”, “CFRA-related field”, or “CFRA field” in the present disclosure.

In some implementations, the CSC MAC CE may include at least one of the following fields: reserved bit(s), target configuration ID, target cell ID, timing advance command, timing advance (TA) value, TCI state ID, UL/DL TCI state ID, DL/UL BWP ID, SRS resource (set) information, CFRA information, and CBRA information. The NW may transmit the CSC MAC CE to the UE. When the UE receives the CSC MAC CE, the UE may change/switch the current serving cell to a candidate target cell based on the CSC MAC CE or based on the information carried/included in the CSC MAC CE (e.g., based on the target configuration ID field in the CSC MAC CE).

In some implementations, the CSC MAC CE may include a TAC field and one or more CFRA information fields (or CFRA-related fields). If a UE receives the CSC MAC CE indicating TA information in the TAC field, the UE may perform a RACH-less LTM. If the UE receives the CSC MAC CE indicating CFRA information in the CFRA information field, the UE may perform a RACH-based (e.g., CFRA) LTM, according to the CFRA information field. If the UE receives the CSC MAC CE with a TA value of the TAC field set to a specific value (e.g., ‘FFF’ in hexadecimal notation, or an invalid value), the UE may perform the RACH procedure for the target cell based on the RACH configuration indicated in the CFRA fields, which may include an SS/PBCH index, a PRACH Mask index, and a Random Access Preamble index.

In some implementations, the UE may receive a CSC MAC CE with one or more CFRA-related fields, which may provide/indicate information corresponding to the CFRA (e.g., a preamble index, a mask index, and/or an SSB index) for an LTM target cell (e.g., the SpCell corresponding to the target configuration, indicated by the Target Configuration ID field in the received CSC MAC CE).

The UE may be configured by the source cell, for example, via RRC signaling, with one or more sets of RACH configurations corresponding to the CFRA-related field (which may be also referred to as the CFRA field). Each set of RACH configuration may be identified by a RACH configuration index. The CFRA field in the MAC CE may indicate a RACH configuration index, which may be used to select a set of RACH configurations for performing the RACH procedure for the LTM target cell. Each set of RACH configurations may include at least one of a preamble index, a mask index, and an SSB index.

In some implementations, the UE may receive a CSC MAC CE with a TAC field, which may provide/indicate the information of whether the TA is valid for an LTM target cell (e.g., the SpCell corresponding to the target configuration, indicated by the Target Configuration ID field in the received CSC MAC CE). More specifically, if the value of the TAC field is set to ‘FFF’ (e.g., all 12 bits are set to ‘1’), the TAC field may indicate that no valid timing adjustment is available for the PTAG of the LTM target cell. In this case, the UE may perform a random access procedure (e.g., CFRA) with the LTM target cell. Otherwise (e.g., when the value of the TAC field is not set to ‘FFF’), the TAC field may indicate the index value Ta that is used to control the amount of timing adjustment that the MAC entity may apply. In this case, the UE may skip the random access procedure for the LTM cell switching, or the UE may perform a RACH-less LTM cell switching.

In some implementations, an LTM candidate cell may be a candidate cell configured to the UE for the LTM. In some implementations, the NW may indicate to the UE to perform a cell switching in the LTM procedure by transmitting the LTM CSC MAC CE to the UE.

In some implementations, when the UE performs a RACH-less LTM cell switching, the UE may not need to trigger a random access procedure for the LTM cell switching (e.g., after receiving the CSC MAC CE). In some implementations, when the UE performs a RACH-less LTM cell switching, the UE may process the received TAC in the CSC MAC CE (e.g., after receiving the CSC MAC CE). In some implementations, the UE may receive an LTM CSC MAC CE including a TAC field with a value set to ‘FFF’, and the UE may perform a RACH-less LTM cell switching after receiving the LTM CSC MAC CE.

In some implementations, when the UE performs a RACH-less LTM cell switching, the UE may indicate to the upper layers (of the UE) to skip the random access procedure (e.g., after receiving the CSC MAC CE). More specifically, the UE may not monitor a DCI format with CRC scrambled by an RA-RNTI, an MsgB-RNTI, or a TC-RNTI in a Type1-PDCCH CSS set on the target cell. In some implementations, when the UE performs a RACH-less LTM cell switching, the UE may consider the RACH-less LTM cell switching is ongoing. More specifically, the UE may determine the RACH-less LTM cell switching is ongoing after the UE receives the (LTM) CSC MAC CE and before the UE receives/detects/monitors a downlink assignment (or a UL grant) on a PDCCH (e.g., a PDCCH scheduling a new DL/UL transmission).

In some implementations, if a value in a TAC field in the CSC MAC CE is not set to ‘FFF’ or the value in the TAC field in the CSC MAC CE is set to 0, the UE may perform at least one of the actions: processing the received TAC, indicating to the upper layers (of the UE) to skip the random access procedure for the LTM cell switching, and considering the RACH-less LTM cell switching is ongoing. More specifically, the UE may not monitor a DCI format with CRC scrambled by an RA-RNTI, an MsgB-RNTI, or a TC-RNTI in a Type1-PDCCH CSS set on the target cell. In some implementations, a UE performing a RACH-less LTM cell switching may perform at least one of the following actions: processing the received TAC, indicating to the upper layers (of the UE) to skip the random access procedure for the LTM cell switching, and considering the RACH-less LTM cell switching is ongoing. More specifically, the UE may not monitor a DCI format with CRC scrambled by an RA-RNTI, an MsgB-RNTI, or a TC-RNTI in a Type1-PDCCH CSS set on the target cell.

In some implementations, when a UE performs a RACH-based LTM cell switching, the UE may need to trigger/initiate a random access procedure for the LTM cell switching (e.g., after receiving a CSC MAC CE). In some implementations, when a UE perform a RACH-based LTM cell switching, the UE may indicate to the upper layers (of the UE) to trigger/initiate a random access procedure (e.g., after receiving a CSC MAC CE). In some implementations, when a UE perform a RACH-based LTM cell switching, the UE may transmit a preamble to the LTM target cell. In some implementations, if a value in a TAC field in the CSC MAC CE is set to ‘FFF’, the UE may indicate to the upper layers (of the UE) to trigger/initiate a random access procedure for this LTM cell switching. In some implementations, when a UE perform a CFRA (LTM) cell switching, the UE may indicate to the upper layers (of the UE) to trigger a random access procedure with the CFRA information in the one or more CFRA-related fields in the CSC MAC CE.

In some implementations, when a UE performs a CBRA (LTM) cell switching, the UE may select a preamble randomly from a pool of preambles shared with other UEs. The UE may transmit the selected preamble, or Msg1, to the NW. The NW may transmit a random access response (RAR), or Msg2, to the UE. The UE may transmit a scheduled UL transmission, or Msg3, to the NW. The NW may transmit a contention resolution, or Msg4, to the UE.

In some implementations, the UE may receive a CSC MAC CE with a target configuration ID for indicating an LTM target cell (e.g., an LTM target cell ID).

In some implementations, a TAC value may be set to zero, provided by higher layer parameters, set to a TA value of the (current) serving cell, or included in the (LTM) CSC MAC CE. In some implementations, when a TAC value is set to zero, provided by higher layer parameters, or set to a TA value of the (current) serving cell, the UE may receive a (LTM) CSC MAC CE with a TAC field, which may be set to a specific value (e.g., ‘FFF’ or other specific values). In some implementations, when a UE is provided with a TAC value, where the TAC value may be set to zero, provided by higher layer parameters, set to a TA value of the (current) serving cell, or included in the (LTM) CSC MAC CE, the UE may perform a RACH-less LTM cell switching.

In some implementations, when (a) a UE receives an LTM CSC MAC CE, (b) the UE is provided with a TAC value, which may be set to zero, provided by higher layer parameters, set to a TA value of the (current) serving cell, or included in the (LTM) CSC MAC CE, and (c) a CFRA-related field is absent (or the CFRA information is not provided) in the LTM CSC MAC CE, the UE may perform a RACH-less LTM cell switching. In some implementations, when a UE is provided with a TAC value, which may be set to zero, provided by higher layer parameters, set to a TA value of the (current) serving cell, or included in the (LTM) CSC MAC CE, the UE may perform at least one of the following actions: processing the received TAC value, indicating to the upper layers (of the UE) to skip the random access procedure for the LTM cell switching, and considering the RACH-less LTM cell switching is ongoing. More specifically, the UE may not monitor a DCI format with CRC scrambled by an RA-RNTI, an MsgB-RNTI, or a TC-RNTI in a Type1-PDCCH CSS set on the target cell.

In some implementations, when (a) a UE receives an LTM CSC MAC CE, (b) the UE is provided with a TAC value, which may be set to zero, provided by higher layer parameters, set to a TA value of the (current) serving cell, or included in the (LTM) CSC MAC CE, and (c) a CFRA-related field is absent (or the CFRA information is not provided) in the LTM CSC MAC CE, the UE may perform a RACH-based LTM cell switching. More specifically, the UE may perform a CFRA RACH-based LTM cell switching and/or a CBRA RACH-based LTM cell switching.

In some implementations, when a UE is provided with a TAC value that is set to zero, provided by higher layer parameters, or set to a TA value of the (current) serving cell, the TAC field (and the CFRA information field) may not be present (or may be absent) in the LTM CSC MAC CE.

In some implementations, the UE may expect to receive a CSC MAC CE that includes either the TAC field or the CFRA information field.

In some implementations, when the UE receives a CSC MAC CE with the value of the TAC field set to ‘FFF’ (or when no valid TA is available, the TAC field is absent, or the TAC field is not present), the CFRA information field in the CSC MAC CE may provide information corresponding to the CFRA (e.g., a preamble index, a mask index, and/or an SSB index) for the LTM target cell. More specifically, the CFRA information field may not be absent, or have to be present, when the value of the TAC field in the CSC MAC CE is set to ‘FFF’ (or when no valid TA is available, the TAC field is absent, or the TAC field is not present). In some implementations, the UE may perform a RACH-based cell switching to the target cell. More specifically, the UE may perform a CFRA cell switching based on the CFRA information field in the CSC MAC CE. In some implementations, the UE may perform a RACH-based cell switching to the target cell. More specifically, the UE may perform a CBRA cell switching.

In some implementations, when the UE receives a CSC MAC CE with the value of the TAC field not set to ‘FFF’ (or when the TAC field indicates an index value of the TA or the TAC field indicates a valid TA value), the CFRA information field in the CSC MAC CE may be absent (or may not be present). In some implementations, the UE may perform a RACH-less LTM cell switching to the target cell. More specifically, the UE may perform a RACH-less LTM cell switching based on the (TA) value in the TAC field. The UE may skip the random access procedure for this LTM cell switching. More specifically, the UE may not monitor a DCI format with CRC scrambled by an RA-RNTI, an MsgB-RNTI, or a TC-RNTI in a Type1-PDCCH CSS set on the target cell.

In some implementations, if (a) a UE receives an (LTM) CSC MAC CE on a serving cell, (b) a TAC value in the (LTM) CSC MAC CE is set as ‘FFF’, and (c) a CFRA information field (or one or more CFRA-related fields) in the (LTM) CSC MAC CE provides the CFRA information (e.g., a preamble index, a mask index, and/or an SSB index) for the LTM target cell, the UE may perform a RACH-based LTM cell switching. In some implementations, when the UE performs the RACH-based LTM cell switching, the UE may need to trigger a random access procedure for the LTM cell switching (e.g., after receiving the CSC MAC CE). In some implementations, when the UE perform the RACH-based LTM cell switching, the UE may indicate to the upper layers (of the UE) to trigger a random access procedure (e.g., after receiving the CSC MAC CE). In some implementations, when the UE perform a CFRA (LTM) cell switching, the UE may indicate to the upper layers (of the UE) to trigger the random access procedure with the CFRA information (e.g., a preamble index, a mask index, and/or an SSB index) in the CFRA information filed in the CSC MAC CE. In some implementations, when the UE performs a CBRA (LTM) cell switching, the UE may select a preamble randomly from a pool of preambles shared with other UEs. The UE may transmit the selected preamble or Msg1 to the NW. The NW may transmit an RAR or Msg2 to the UE. The UE may transmit a scheduled UL transmission or Msg3 to the NW. The NW may transmit a contention resolution or Msg4 to the UE. In some implementations, the UE may monitor a DCI format with CRC scrambled by an RA-RNTI, an MsgB-RNTI, or a TC-RNTI in a Type1-PDCCH CSS set on the target cell.

In some implementations, if (a) a UE receives an (LTM) CSC MAC CE on a serving cell, (b) a TAC value is not set as ‘FFF’, and (c) a CFRA information field (or one or more CFRA-related fields) is absent in the (LTM) CSC MAC CE, the UE may perform a RACH-less LTM cell switching. In some implementations, the absence of the CFRA-related field may mean that the CFRA-related field refers to the value in the TAC field. For example, the value of the CFRA-related field may be derived from or correspond to the value of the TAC field. In other words, the CFRA-related field may be indirectly defined by the TAC field in the absence of explicit CFRA information.

In some implementations, the (LTM) CSC MAC CE may include a field for indicating whether the CFRA-related field is present/absent. In some implementations, if the CFRA information is not provided/configured by a higher layer (e.g., the RRC layer), the UE may not expect to receive a (LTM) CSC MAC CE in which the CFRA-related field is absent. In some implementations, if the CFRA information is not provided/configured by a higher layer (e.g., the RRC layer), the UE may expect to receive a (LTM) CSC MAC CE with the CFRA-related field including information such as a preamble index, a mask index, and/or an SSB index. In some implementations, when a UE performs a RACH-less LTM cell switching, the UE may not need to trigger a random access procedure (e.g., with the target cell) for the LTM cell switching (e.g., after receiving a CSC MAC CE). In some implementations, when a UE performs a RACH-less LTM cell switching, the UE may process the received TAC value in the (LTM) CSC MAC CE (e.g., after receiving the CSC MAC CE). In some implementations, when a UE performs a RACH-less LTM cell switching, the UE may indicate to the upper layers (of the UE) to skip the random access procedure (e.g., after receiving the CSC MAC CE). More specifically, the UE may not monitor a DCI format with CRC scrambled by an RA-RNTI, an MsgB-RNTI, or a TC-RNTI in a Type1-PDCCH CSS set on the target cell. In some implementations, when a UE performs a RACH-less LTM cell switching, the UE may consider the RACH-less LTM cell switching is ongoing. In some implementations, if a value in a TAC field in the (LTM) CSC MAC CE is not set to ‘FFF’ and a CFRA information field (or one or more CFRA-related fields) is absent in the (LTM) CSC MAC CE, the UE may perform at least one of the following actions: processing the received TAC, indicating to the upper layers (of the UE) to skip the random access procedure for the LTM cell switching, and considering the RACH-less LTM cell switching is ongoing. More specifically, the UE may not monitor a DCI format with CRC scrambled by an RA-RNTI, an MsgB-RNTI, or a TC-RNTI in a Type1-PDCCH CSS set on the target cell.

In some implementations, when a CSC MAC CE includes a CFRA information field (or one or more CFRA-related fields) that may include/indicate/provide a preamble index, a mask index, and/or an SSB index, the TAC field may be absent in the CSC MAC CE (or the TAC field may indicate an invalid TA, the TAC field may not be present, or the TAC field may be set to ‘FFF’). In some implementations, the UE may perform a RACH-based cell switching to the target cell. For example, the UE may perform a CFRA cell switching based on the CFRA information field. For example, the UE may perform a CBRA cell switching by transmitting a preamble to the LTM target cell.

In some implementations, when the UE receives a CSC MAC CE in which a CFRA information field is absent or no CFRA information is provided in the CFRA information field (or one or more CFRA-related fields), a value of the TAC field in the CSC MAC CE may not be set to ‘FFF’ (or the TAC field may indicate an index value of TA, or the TAC field may indicate a valid TA value). In some implementations, the UE may perform a RACH-less LTM cell switching to the target cell. More specifically, the UE may perform a RACH-less LTM cell switching based on the (TA) value of the TAC field.

In some implementations, if a UE receives an (LTM) CSC MAC CE on a serving cell and a CFRA information field (or one or more CFRA-related fields) in the (LTM) CSC MAC CE provides the CFRA information (e.g., a preamble index, a mask index, and/or an SSB index), the UE may perform a RACH-based LTM cell switching. In some implementations, when the UE perform the RACH-based LTM cell switching, the UE may need to trigger a random access procedure for the LTM cell switching (e.g., after receiving the CSC MAC CE). In some implementations, when the UE performs the RACH-based LTM cell switching, the UE may indicate to the upper layers (of the UE) to trigger a random access procedure (e.g., after receiving the CSC MAC CE). In some implementations, when the UE performs a CFRA (LTM) cell switching, the UE may indicate to the upper layers (of the UE) to trigger the random access procedure with the CFRA information (e.g., a preamble index, a mask index, and/or an SSB index) in the CFRA information filed in the CSC MAC CE.

In some implementations, if a UE receives an (LTM) CSC MAC CE on a serving cell and a CFRA information field (or one or more CFRA-related fields) in the (LTM) CSC MAC CE is absent, the UE may perform a RACH-less LTM cell switching. In some implementations, when the UE perform the RACH-less LTM cell switching, the UE may not need to trigger a random access procedure for the LTM cell switching (e.g., after receiving the CSC MAC CE). In some implementations, when the UE perform the RACH-less LTM cell switching, the UE may process a received TAC value in the (LTM) CSC MAC CE (e.g., after receiving the CSC MAC CE). In some implementations, when the UE perform the RACH-less LTM cell switching, the UE may indicate to the upper layers (of the UE) to skip the random access procedure (e.g., after receiving the CSC MAC CE). More specifically, the UE may not monitor a DCI format with CRC scrambled by an RA-RNTI, an MsgB-RNTI, or a TC-RNTI in a Type1-PDCCH CSS set on the target cell. In some implementations, when the UE performs the RACH-less LTM cell switching, the UE may consider the RACH-less LTM cell switching is ongoing. In some implementations, if the CFRA information field in the (LTM) CSC MAC CE is absent, the UE may perform at least one of the following actions: processing the received TAC, indicating to the upper layers (of the UE) to skip the random access procedure for the LTM cell switching, and considering the RACH-less LTM cell switching is ongoing. More specifically, the UE may not monitor a DCI format with CRC scrambled by an RA-RNTI, an MsgB-RNTI, or a TC-RNTI in a Type1-PDCCH CSS set on the target cell.

In some implementations, the UE may receive a CSC MAC CE that includes the TAC field and the CFRA information field.

In some implementations, when a UE receives a CSC MAC CE that includes a TAC field not set to ‘FFF’ (or the TAC field indicates an index value of TA, or the TAC field indicates a valid TA value) and that includes a CFRA-related field that provides/includes/indicates information corresponding to the CFRA (e.g., a preamble index, a mask index, and/or an SSB index) for the LTM target cell, the UE may perform a RACH-based cell switching to the LTM target cell. For example, the UE may perform a CFRA cell switching based on the CFRA-related field. For example, the UE may perform a CBRA (LTM) cell switching. For example, the UE may transmit a PRACH and/or Msg3 to the BS/LTM target cell after receiving the CSC MAC CE. In some implementations, the UE may always perform the CFRA. In some implementations, the UE may always perform the CBRA.

In some implementations, when a UE receives a CSC MAC CE that includes a TAC field not set to ‘FFF’ (or the TAC field indicates an index value of TA, or the TAC field indicates a valid TA value) and that includes a CFRA-related field that provides/includes/indicates information corresponding to the CFRA (e.g., a preamble index, a mask index, and/or an SSB index) for the LTM target cell, the UE may perform a RACH-less LTM cell switching to the LTM target cell. More specifically, the UE may perform the RACH-less LTM cell switching based on the (TA) value in the TAC field, or the UE may skip the random access procedure for this LTM cell switching. More specifically, the UE may transmit UL data through a PUSCH or a CG PUSCH to the BS/LTM target cell after receiving the CSC MAC CE.

In some implementations, when a UE receives a CSC MAC CE that includes a TAC field not set to ‘FFF’ (or the TAC field indicates an index value of TA, or the TAC field indicates a valid TA value) CFRA-related field that provides/includes/indicates information corresponding to the CFRA (e.g., a preamble index, a mask index, and/or an SSB index) for the LTM target cell, the UE may first perform a RACH-less LTM cell switching to the LTM target cell based on the (TA) value in the TAC field, and may then perform a CFRA cell switching to the LTM target cell based on the CFRA-related field when the RACH-less LTM cell switching to the LTM target cell fails.

More specifically, the UE may first perform the RACH-less LTM cell switching based on the (TA) value in the TAC field. If the UE does not receive/detect/monitor a UL grant on a PDCCH with a DCI format (e.g., DCI format 0-0, DCI format 0-1, or DCI format 0-2) with CRC scrambled by a C-RNTI, CS-RNTI, or MCS C-RNTI (e.g., scheduling a new UL transmission) after the first PUSCH is transmitted to the LTM target cell, the UE may perform a RACH-based (e.g., CFRA based on the CFRA-related field or CBRA) LTM cell switching. The UL grant may be for a new transmission after the first PUSCH transmission at the serving cell or the LTM target cell.

More specifically, the UE may first perform the RACH-less LTM cell switching based on the (TA) value in the TAC field. If the UE dose not receive/detect/monitor a downlink assignment on a PDCCH (e.g., scheduling a new DL transmission) after the first PUSCH is transmitted to the LTM target cell, the UE may perform a RACH-based (e.g., CFRA based on the CFRA-related field or CBRA) LTM cell switching. The downlink assignment may be for a new transmission after the first PUSCH transmission at the serving cell or the LTM target cell.

In some implementations, when a UE performs a CFRA LTM cell switching based on the CFRA information field and the UE does not receive a RAR from the NW, the UE may perform a CBRA LTM cell switching. In some implementations, an NDI field in a PDCCH may be toggled if the scheduled PDSCH/PUSCH is a new transmission. In some implementations, when a UE receives a CSC MAC CE that includes a TAC field not set to ‘FFF’ (or the TAC field indicates an index value of TA, or the TAC field indicates a valid TA value) for the LTM target cell and a CFRA-related field is present (or not absent) in the CSC MAC CE, the UE may perform a RACH-based cell switching to the (LTM) target cell. More specifically, the UE may perform a CFRA cell switching based on the CFRA-related field. More specifically, the UE may perform a CBRA. In some implementations, the UE may always perform the CFRA. In some implementations, the UE may always perform the CBRA.

In some implementations, when a UE receives a CSC MAC CE including a TAC field not set to ‘FFF’ (or the TAC field indicates an index value of TA, or the TAC field indicates a valid TA value) for the LTM target cell and a CFRA-related field is present (or not absent) in the CSC MAC CE, the UE may perform a RACH-less LTM cell switching. More specifically, the UE may perform the RACH-less LTM cell switching based on the (TA) value in the TAC field, or the UE may skip the random access procedure for this LTM cell switching.

In some implementations, when a UE receives a CSC MAC CE including a TAC field not set to ‘FFF’ (or when no valid TA is available, the TAC field is absent, or the TAC field is not present) for the LTM target cell and a CFRA-related field is present (or not absent) in the CSC MAC CE, the UE may first perform a RACH-less LTM cell switching based on the (TA) value of the TAC field and perform a CFRA cell switching based on the CFRA-related field.

More specifically, the UE may first perform the RACH-less LTM cell switching based on the (TA) value of the TAC field. If the UE dose not receive/detect/monitor a UL grant on a PDCCH (e.g., scheduling a new UL transmission) after the first PUSCH is transmitted, the UE may perform the RACH-based (e.g., CFRA based on the CFRA-related field or CBRA) LTM cell switching. The UL grant may be for a new transmission after the first PUSCH transmission at the serving cell or the LTM target cell.

More specifically, the UE may first perform the RACH-less LTM cell switching based on the (TA) value of the TAC field. If the UE does not receive/detect/monitor a downlink assignment on a PDCCH (e.g., scheduling a new DL transmission) after the first PUSCH is transmitted to the LTM target cell, the UE may perform the RACH-based (e.g., CFRA based on the CFRA-related field or CBRA) LTM cell switching. The downlink assignment may be for a new transmission after the first PUSCH transmission at the serving cell or the LTM target cell. In some implementations, when the UE performs the CFRA LTM cell switching based on the CFRA-related field and the UE does not receive a RAR from the NW, the UE may perform the CBRA LTM cell switching.

In some implementations, the UE may receive a CSC MAC CE that does not include the TAC field and the CFRA information field.

In some implementations, if the TA value of the candidate target cell indicated in the CSC MAC CE is configured to be the same as the TA value of the source cell/serving cell by the source cell via RRC signaling during the RRC pre-configuration step, the TAC field and/or CFRA information field(s) may be absent (or not present) in the CSC MAC CE may be absent.

In some implementations, when a UE receives a CSC MAC CE that includes a TAC field with the value set to ‘FFF’ (or the TAC field indicating an index value of TA, or the TAC field indicating a valid TA value) for the LTM target cell and that includes a CFRA information field (or one or more CFRA-related fields) without CFRA information, the UE may perform a RACH-based (e.g., CBRA) cell switching to the LTM target cell. More specifically, the UE may perform the CBRA (LTM) cell switching.

In some implementations, when a UE receives a CSC MAC CE that includes a TAC field with the value set to ‘FFF’ (or the TAC field indicating an index value of TA, or the TAC field indicating a valid TA value) for the LTM target cell and that does not include a CFRA information field, the UE may perform a RACH-based (e.g., CBRA) cell switching. More specifically, the UE may perform the CBRA (LTM) cell switching. More specifically, the UE may perform a 2-step RACH for the (LTM) cell switching. More specifically, the UE may transmit a preamble and PUSCH to the NW. The NW may transmit the RAR, PDCCH, and/or PDSCH to the UE.

In an aspect of the present disclosure, a method performed by a UE for a cell switching operation is provided. The method may include receiving, from a BS, a MAC CE including at least one of a first information field and a second information field, where the first information field may indicate/provide TA information and the second information field may indicate/provide CFRA information; and performing at least one of a RACH-less and a RACH-based cell switching to an LTM target cell based on the first information field and the second information field in the MAC CE.

In some implementations, an LTM target cell index of the LTM target cell may be indicated by a third information field in the MAC CE. The third information field may include a target configuration ID.

In some implementations, the first information field may indicate/provide the TA information via a value in the first information field. In a case the value is set to ‘FFF’, the first information field may indicate that no valid timing adjustment is available for the PTAG of the LTM target cell. In a case the value is not set to ‘FFF’, the first information field may indicate an index value TA used to control the amount of timing adjustment that the MAC entity may apply.

In some implementations, the second information field may indicate/provide the CFRA information, where the CFRA information may include at least one of a preamble index, a mask index, and an SSB index of the LTM target cell.

In some implementations, in a case that the value of the first information field is set to ‘FFF’ (or no valid TA is available in the first information field, or the first information field is absent, or the first information field is not present), the second information field may be (always) present or not absent.

In some implementations, in a case that the value of the first information field is set to ‘FFF’ (or no valid TA is available in the first information field, or the first information field is absent, or the first information field is not present), the UE may perform a RACH-based (e.g., CFRA or CBRA) cell switching to the LTM target cell.

In some implementations, in a case that the value of the first information field is set to ‘FFF’ (or no valid TA is available in the first information field, or the first information field is absent, or the first information field is not present) and the second information field is not absent (or the second information is present, or the second information field indicates/provides the CFRA information), the UE may perform a RACH-based cell switching to the LTM target cell based on the CFRA information in the second information field.

In some implementations, in a case that the value of the first information field is not set to ‘FFF’, the second information field may be absent or not present.

In some implementations, in a case that the value of the first information field is not set to ‘FFF’, the UE may perform a RACH-less LTM cell switching to the LTM target cell. The UE may use the value of the first information field for the RACH-less LTM cell switching.

In some implementations, in a case that the value of the first information field is not set to ‘FFF’ and the second field is absent or not present, the UE may perform a RACH-less LTM cell switching to the LTM target cell. The UE may use the value of the first information field for the RACH-less LTM cell switching.

In some implementations, in a case that the first information field is not set to ‘FFF’ and the second information field is present or not absent, the UE may perform a RACH-less LTM cell switching based on the TA information in the first information field or a RACH-based cell switching based on the CFRA information in the second information field.

In some implementations, in a case that the first information field is not set to ‘FFF’ and the second information field is present or not absent, the UE may perform a RACH-less LTM cell switching based on the TA information in the first information field first and may then perform a RACH-based cell switching based on the CFRA information in the second information field.

In some implementations, in a case that the first information field is set to ‘FFF’ (or no valid TA value is indicated) and the second information field is absent or not present, the UE may perform a CBRA cell switching.

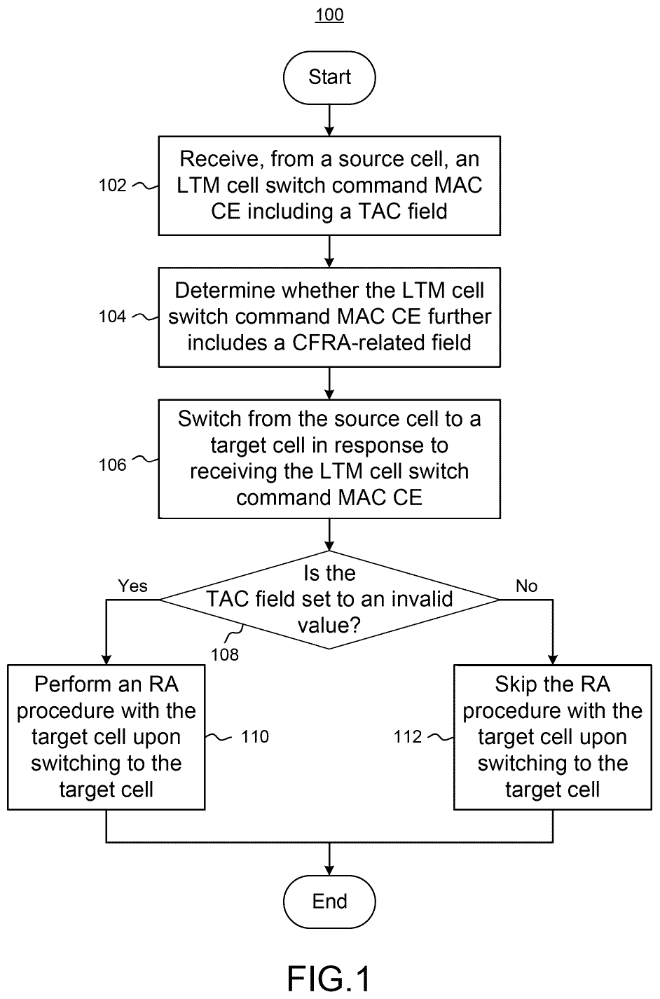

FIG. 1 is a flowchart illustrating a method/process 100 performed by a UE for an LTM operation, according to an example implementation of the present disclosure. In the action 102, the process 100 may start by receiving, from a source cell, an LTM cell switch command MAC CE that includes at least a TAC field.

In the action 104, the process 100 may determine whether the LTM cell switch command MAC CE further includes a CFRA-related field. In some implementations, the CFRA-related field may include at least one of a preamble index, a mask index, and an SSB index. In some implementations, the LTM cell switch command MAC CE may further include an indication field that indicates whether the LTM cell switch command MAC CE includes the CFRA-related field.

In the action 106, the process 100 may switch from the source cell to a target cell in response to receiving the LTM cell switch command MAC CE. In the action 108, the process 100 may determine whether the TAC field is set to an invalid value.

In a case that the TAC field is set to an invalid value, in the action 110, the process 100 may perform an RA procedure with the target cell upon switching to the target cell, where a type of the RA procedure may depend on whether the LTM cell switch command MAC CE includes the CFRA-related field. In some implementations, the invalid value may be ‘FFF’ in hexadecimal notation.

In a case that the TAC field is set to a valid value, in the action 112, the process 100 may skip the RA procedure with the target cell upon switching to the target cell. In some implementations, the valid value may correspond to an index of a TA value for the target cell. The process 100 may then end.

The type of the RA procedure may depend on whether the LTM cell switch command MAC CE includes the CFRA-related field. In some implementations, the type of the RA procedure may be a CFRA type in a case that the LTM cell switch command MAC CE includes the CFRA-related field. The type of the RA procedure may be a CBRA type in a case that the LTM cell switch command MAC CE does not include the CFRA-related field.

In some implementations, performing the RA procedure with the target cell may include monitoring a DCI format with CRC scrambled by an RA-RNTI, an MsgB-RNTI, or a TC-RNTI in a search space on the target cell.

The steps/actions shown in FIG. 1 should not be construed as necessarily order dependent. The order in which the process is described is not intended to be construed as a limitation. Moreover, some of the actions shown in FIG. 1 may be omitted in some implementations and one or more actions shown in FIG. 1 may be combined.

The technical problem addressed by the method illustrated in FIG. 1 is how to efficiently manage and perform a cell switching in an LTM operation for a UE while optimizing the timing and resource allocation, particularly with respect to determining when to perform or skip the RA procedure. The method may provide an advantageous effect by allowing the UE to selectively perform or skip the RA procedure based on the value of the TAC field value and to determine the type of the RA procedure based on the presence/absence of the CFRA-related field. As such, the UE may skip the RA procedure when the TAC field is valid, which may reduce latency and speed up the switch to the target cell. The UE may perform the RA procedure when the TAC field is invalid, which may ensure synchronization is maintained when necessary. In addition, determining the type of the RA procedure based on the presence of the CFRA-related field may further optimize resource usage and handover efficiency, improving overall network performance during mobility operations.

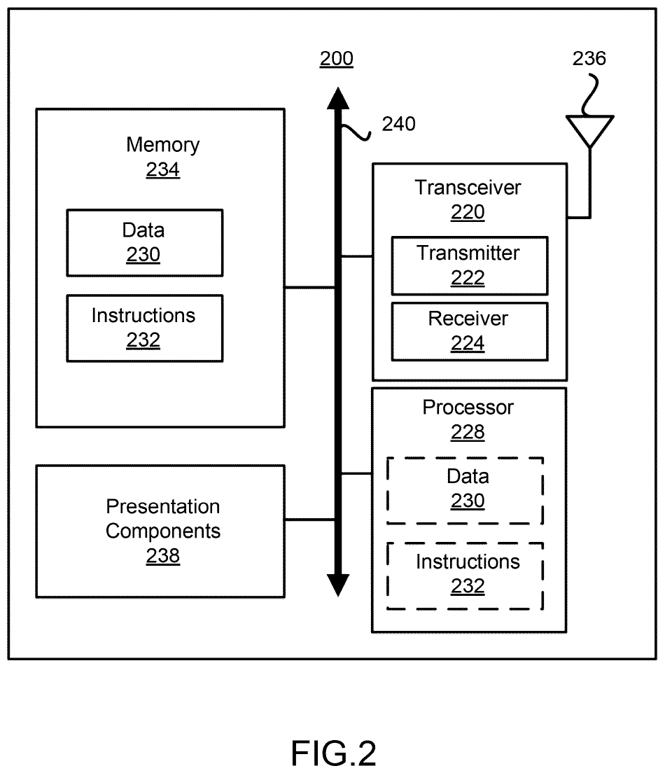

FIG. 2 is a block diagram illustrating a node 200 for wireless communication in accordance with various aspects of the present disclosure. As illustrated in FIG. 2, a node 200 may include a transceiver 220, a processor 228, a memory 234, one or more presentation components 238, and at least one antenna 236. The node 200 may also include a radio frequency (RF) spectrum band module, a BS communications module, a network communications module, and a system communications management module, Input/Output (I/O) ports, I/O components, and a power supply (not illustrated in FIG. 2).

Each of the components may directly or indirectly communicate with each other over one or more buses 240. The node 200 may be a UE or a BS that performs various functions disclosed with reference to FIG. 1.

The transceiver 220 has a transmitter 222 (e.g., transmitting/transmission circuitry) and a receiver 224 (e.g., receiving/reception circuitry) and may be configured to transmit and/or receive time and/or frequency resource partitioning information. The transceiver 220 may be configured to transmit in different types of subframes and slots including, but not limited to, usable, non-usable, and flexibly usable subframes and slot formats. The transceiver 220 may be configured to receive data and control channels.

The node 200 may include a variety of computer-readable media. Computer-readable media may be any available media that may be accessed by the node 200 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the above listed components should also be included within the scope of computer-readable media.

The memory 234 may include computer-storage media in the form of volatile and/or non-volatile memory. The memory 234 may be removable, non-removable, or a combination thereof. Example memory may include solid-state memory, hard drives, optical-disc drives, etc. As illustrated in FIG. 2, the memory 234 may store a computer-readable and/or computer-executable instructions 232 (e.g., software codes) that are configured to, when executed, cause the processor 228 to perform various functions disclosed herein, for example, with reference to FIG. 1. Alternatively, the instructions 232 may not be directly executable by the processor 228 but may be configured to cause the node 200 (e.g., when compiled and executed) to perform various functions disclosed herein.

The processor 228 (e.g., having processing circuitry) may include an intelligent hardware device, e.g., a Central Processing Unit (CPU), a microcontroller, an ASIC, etc. The processor 228 may include memory. The processor 228 may process the data 230 and the instructions 232 received from the memory 234, and information transmitted and received via the transceiver 220, the baseband communications module, and/or the network communications module. The processor 228 may also process information to send to the transceiver 220 for transmission via the antenna 236 to the network communications module for transmission to a CN.

One or more presentation components 238 may present data indications to a person or another device. Examples of presentation components 238 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a User Equipment (UE) for a Layer1/Layer2 Triggered Mobility (LTM) operation, the method comprising:
receiving, from a source cell, an LTM cell switch command Medium Access Control (MAC) Control Element (CE) comprising a Timing Advance Command (TAC) field;
determining whether the LTM cell switch command MAC CE further comprises a Contention-Free Random Access (CFRA)-related field;
switching from the source cell to a target cell in response to receiving the LTM cell switch command MAC CE;
in a case that the TAC field is set to an invalid value, performing a Random Access (RA) procedure with the target cell upon switching to the target cell, wherein a type of the RA procedure depends on whether the LTM cell switch command MAC CE comprises the CFRA-related field; and
in a case that the TAC field is set to a valid value, skipping the RA procedure with the target cell upon switching to the target cell.

2. The method of claim 1, wherein:
the type of the RA procedure is a CFRA type in a case that the LTM cell switch command MAC CE comprises the CFRA-related field, and
the type of the RA procedure is a Contention-Based Random Access (CBRA) type in a case that the LTM cell switch command MAC CE does not comprise the CFRA-related field.

3. The method of claim 1, wherein the CFRA-related field comprises at least one of a preamble index, a mask index, and a Synchronization Signal/Physical Broadcast Channel (SS/PBCH) Block (SSB) index.

4. The method of claim 1, wherein the invalid value is ‘FFF’ in hexadecimal notation.

5. The method of claim 1, wherein the valid value corresponds to an index of a Timing Advance (TA) value for the target cell.

6. The method of claim 1, wherein the LTM cell switch command MAC CE further comprises an indication field for indicating whether the LTM cell switch command MAC CE comprises the CFRA-related field.

7. The method of claim 1, wherein performing the RA procedure with the target cell comprises:
monitoring a Downlink Control Information (DCI) format with Cyclic Redundancy Check (CRC) scrambled by a Random Access-Radio Network Temporary Identifier (RA-RNTI), a Message B-RNTI (MsgB-RNTI), or a Temporary Cell-RNTI (TC-RNTI) in a search space on the target cell.

8. A User Equipment (UE) for a Layer1/Layer2 Triggered Mobility (LTM) operation, the UE comprising:
at least one processor; and
at least one non-transitory computer-readable medium coupled to the at least one processor and storing one or more computer-executable instructions that, when executed by the at least one processor, cause the UE to:
receive, from a source cell, an LTM cell switch command Medium Access Control (MAC) Control Element (CE) comprising a Timing Advance Command (TAC) field;
determine whether the LTM cell switch command MAC CE further comprises a Contention-Free Random Access (CFRA)-related field;
switch from the source cell to a target cell in response to receiving the LTM cell switch command MAC CE;
in a case that the TAC field is set to an invalid value, perform a Random Access (RA) procedure with the target cell upon switching to the target cell, wherein a type of the RA procedure depends on whether the LTM cell switch command MAC CE comprises the CFRA-related field; and
in a case that the TAC field is set to a valid value, skip the RA procedure with the target cell upon switching to the target cell.

9. The UE of claim 8, wherein:
the type of the RA procedure is a CFRA type in a case that the LTM cell switch command MAC CE comprises the CFRA-related field, and
the type of the RA procedure is a Contention-Based Random Access (CBRA) type in a case that the LTM cell switch command MAC CE does not comprise the CFRA-related field.

10. The UE of claim 8, wherein the CFRA-related field comprises at least one of a preamble index, a mask index, and a Synchronization Signal/Physical Broadcast Channel (SS/PBCH) Block (SSB) index.

11. The UE of claim 8, wherein the invalid value is ‘FFF’ in hexadecimal notation.

12. The UE of claim 8, wherein the valid value corresponds to an index of a Timing Advance (TA) value for the target cell.

13. The UE of claim 8, wherein the LTM cell switch command MAC CE further comprises an indication field for indicating whether the LTM cell switch command MAC CE comprises the CFRA-related field.

14. The UE of claim 8, wherein performing the RA procedure with the target cell comprises:
monitoring a Downlink Control Information (DCI) format with Cyclic Redundancy Check (CRC) scrambled by a Random Access-Radio Network Temporary Identifier (RA-RNTI), a Message B-RNTI (MsgB-RNTI), or a Temporary Cell-RNTI (TC-RNTI) in a search space on the target cell.

15. A Base Station (BS) for a Layer1/Layer2 Triggered Mobility (LTM) operation, the BS comprising:
at least one processor; and
at least one non-transitory computer-readable medium coupled to the at least one processor and storing one or more computer-executable instructions that, when executed by the at least one processor, cause the BS to:
transmit, to a User Equipment (UE), via a source cell associated with the BS, an LTM cell switch command Medium Access Control (MAC) Control Element (CE) comprising a Timing Advance Command (TAC) field, wherein the UE:
determines whether the LTM cell switch command MAC CE further comprises a Contention-Free Random Access (CFRA)-related field,
switches from the source cell to a target cell in response to receiving the LTM cell switch command MAC CE,
in a case that the TAC field is set to an invalid value, performs a Random Access (RA) procedure with the target cell upon switching to the target cell, wherein a type of the RA procedure depends on whether the LTM cell switch command MAC CE comprises the CFRA-related field, and
in a case that the TAC field is set to a valid value, skips the RA procedure with the target cell upon switching to the target cell.

16. The BS of claim 15, wherein:
the type of the RA procedure is a CFRA type in a case that the LTM cell switch command MAC CE comprises the CFRA-related field, and
the type of the RA procedure is a Contention-Based Random Access (CBRA) type in a case that the LTM cell switch command MAC CE does not comprise the CFRA-related field.

17. The BS of claim 15, wherein the CFRA-related field comprises at least one of a preamble index, a mask index, and a Synchronization Signal/Physical Broadcast Channel (SS/PBCH) Block (SSB) index.

18. The BS of claim 15, wherein the invalid value is ‘FFF’ in hexadecimal notation.

19. The BS of claim 15, wherein the valid value corresponds to an index of a Timing Advance (TA) value for the target cell.

20. The BS of claim 15, wherein the LTM cell switch command MAC CE further comprises an indication field for indicating whether the LTM cell switch command MAC CE comprises the CFRA-related field.
